(19) United States
(12) Patent Application Publication
(10) Pub. No.: US 2023/0411067 A1
(43) Pub. Date: Dec. 21, 2023

(54) ELECTRONIC COMPONENT, COIL COMPONENT, AND METHOD FOR MANUFACTURING ELECTRONIC COMPONENT

(71) Applicant: Murata Manufacturing Co., Ltd., Kyoto-fu (JP)

(72) Inventors: Yuuki KAWAKAMI, Nagaokakyo-shi (JP); Ryuichiro TOMINAGA, Nagaokakyo-shi (JP); Keisuke KUNIMORI, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 18/333,356

(22) Filed: Jun. 12, 2023

(30) Foreign Application Priority Data
Jun. 17, 2022 (JP) 2022-098412

(51) Int. Cl. H01F 27/28; H01F 41/04; H01F 27/29; H01F 27/32; H01F 41/12

(52) U.S. Cl. CPC H01F 27/2804; H01F 41/043; H01F 27/29; H01F 27/324; H01F 41/125; H01F 2027/2809; H01F 41/127; H01F 27/24

(57) ABSTRACT

In an electronic component including a circuit pattern embedded in an insulating layer, connection reliability between the circuit pattern and a wiring conductor outside the insulating layer is improved. An electronic component includes an insulating layer; a circuit pattern embedded in the insulating layer; a wiring conductor formed outside the insulating layer; and an interlayer connection portion that connects a circuit connection portion, which is a part of the circuit pattern, and the wiring conductor with an opening of the insulating layer interposed therebetween. In the circuit pattern, a thickness of a portion immediately below the interlayer connection portion of the circuit connection portion is larger than an average thickness of a portion other than the circuit connection portion.

### CROSS-REFERENCE TO RELATED APPLICATION

This application claims benefit of priority to Japanese Patent Application No. 2022-098412, filed Jun. 17, 2022, the entire content of which is incorporated herein by reference.

### BACKGROUND

### Technical Field

The present disclosure relates to an electronic component, a coil component, and a method for manufacturing an electronic component.

### Background Art

Conventionally, there has been known a coil component configured by embedding a coil portion formed by a plurality of wiring layers including spiral circuit patterns formed of plated wirings, insulating layers formed between the plated wirings and between the wiring layers, and interlayer connection portions electrically connecting a part of the circuit pattern of each wiring layer in a magnetic pulse-containing resin as described, for example, in Japanese Patent Application Laid-Open No. 2020-136467.

### SUMMARY

In the coil component described above, stress is applied to the interlayer connection portion as the temperature rises or the environmental temperature changes during operation. It is considered that this stress concentrates on the bottom surface of the interlayer connection portion, and the connection is broken from there. For this reason, when the distance of the circuit patterns between the two adjacent wiring layers is large and the interlayer connection portion is thick, the generated stress is also large, and there is a concern that the connection reliability of the interlayer connection portion is lowered. In addition, in a case where a circuit pattern of another wiring layer is plated and formed on a circuit pattern of one wiring layer, when the circuit pattern of another wiring layer is continuously plated and formed on a thick interlayer connection portion, a recess is likely to occur at a position corresponding to the interlayer connection portion on the upper surface of the circuit pattern of the another wiring layer, and this recess may lower the connection reliability of the circuit patterns between these wiring layers.

Accordingly, the present disclosure improves connection reliability between a circuit pattern and a wiring conductor outside an insulating layer in an electronic component including the circuit pattern embedded in the insulating layer.

One aspect of the present disclosure is an electronic component including an insulating layer; a circuit pattern embedded in the insulating layer; a wiring conductor formed outside the insulating layer; and an interlayer connection portion that connects a circuit connection portion, which is a part of the circuit pattern and the wiring conductor, with an opening of the insulating layer interposed therebetween. In the circuit pattern, a thickness of a portion immediately below the interlayer connection portion of the circuit connection portion is larger than an average thickness of a portion other than the circuit connection portion.

Another aspect of the present disclosure is a method for manufacturing an electronic component. The method includes a step of forming a plurality of insulating walls arranged at predetermined intervals on a metal layer; and a step of forming a circuit pattern by plating and growing a metal between the insulating walls by electrolytic plating. In the step of forming the insulating walls, a wide opening portion is formed by making at least one of the intervals be larger than others of the intervals. In the step of forming the circuit pattern, a circuit pattern having a thickness of the wide opening portion that is larger than that of the other opening portion is formed by setting a current density in the electrolytic plating to 10 ASD or more.

Another aspect of the present disclosure is a method for manufacturing an electronic component. The method includes a step of forming a plurality of insulating walls arranged at predetermined intervals on a metal layer; and a step of forming a circuit pattern by plating and growing a metal between the insulating walls by electrolytic plating. In the step of forming the insulating walls, a wide opening portion is formed by making at least one of the intervals be larger than others of the intervals, and photosensitive resin is exposed to irradiation light with respect to a surface of the photosensitive resin formed on the metal layer from a projection exposure device set to off-focus, so that a section of the insulating wall along a plane orthogonal to an extending direction of the circuit pattern is formed in a reverse tapered shape in which a width decreases toward the metal layer. Also, the step of forming the circuit pattern includes forming the circuit pattern having a thickness of the wide opening portion that is larger than that of the other opening portion by making circulation of a plating solution flowing into the opening portion less likely to occur in the other opening portion than the wide opening portion by the insulating wall having a reverse tapered shape.

According to the present disclosure, it is possible to improve the connection reliability between the circuit pattern and the wiring conductor outside the insulating layer in the electronic component including the circuit pattern embedded in the insulating layer.

### BRIEF DESCRIPTION OF THE DRAWINGS

FIG. 1 is a schematic view illustrating an internal structure of a coil component according to a first embodiment of the present disclosure;

FIG. 2 is a detailed view of a wiring layer in a portion A in FIG. 1;

FIG. 3 is a view illustrating manufacturing steps of the coil component illustrated in FIG. 1;

FIG. 4 is a view illustrating manufacturing steps of the coil component illustrated in FIG. 1, which is subsequent to FIG. 3;

FIG. 5 is a view illustrating manufacturing steps of the coil component illustrated in FIG. 1, which is subsequent to FIG. 4;

FIG. 6 is a schematic view illustrating an internal structure of a coil component according to a second embodiment of the present disclosure;

FIG. 7 is a detailed view of a wiring layer in a portion B of FIG. 6;

FIG. 8 is a view illustrating manufacturing steps of the coil component illustrated in FIG. 6;

FIG. 9 is a view illustrating manufacturing steps of the coil component illustrated in FIG. 6, which is subsequent to FIG. 8;

FIG. 10 is a view illustrating manufacturing steps of the coil component illustrated in FIG. 6, which is subsequent to FIG. 9;

FIG. 11 is a schematic view illustrating an internal structure of a coil component according to a third embodiment of the present disclosure;

FIG. 12 is a detailed view of a wiring layer in a portion C of FIG. 11;

FIG. 13 is a view illustrating manufacturing steps of the coil component illustrated in FIG. 11;

FIG. 14 is a view illustrating manufacturing steps of the coil component illustrated in FIG. 11, which is subsequent to FIG. 13;

FIG. 15 is a view illustrating manufacturing steps of the coil component illustrated in FIG. 11, which is subsequent to FIG. 14; and

FIG. 16 is a schematic view illustrating an internal structure of a coil component according to a fourth embodiment of the present disclosure.

### DETAILED DESCRIPTION

Hereinafter, embodiments of the present disclosure will be described with reference to the drawings.

In the following embodiment, a coil component will be described as an example of an electronic component. The drawings may include schematic views at a part thereof. In addition, dimensions and ratios in the schematic views may be different from actual numerical values.

### First Embodiment

First, a first embodiment will be described.

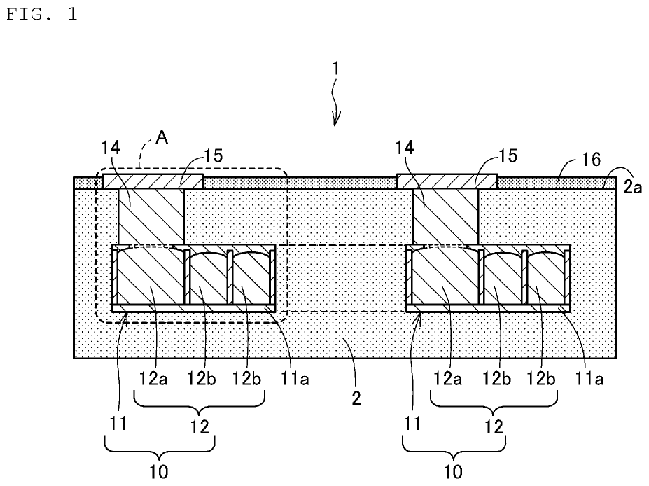

FIG. 1 is a schematic view illustrating an internal structure of a coil component 1 according to the present embodiment.

The coil component 1 includes an insulating layer 11 and a circuit pattern 12 embedded in the insulating layer 11. The insulating layer 11 and the circuit pattern 12 constitute a wiring layer 10. The wiring layer 10 has a ring shape in plan view as viewed from above in the drawing, and the circuit pattern 12 is formed inside in a spiral shape in plan view to form a coil portion. Here, FIG. 1 illustrates a section along a plane orthogonal to the extending direction of the circuit pattern 12.

The insulating layer 11 is mainly made of an insulating material, and is, for example, an insulating resin. The insulating material may contain a filler material mainly made of silicon oxide (SiO₂) or aluminum oxide (Al₂O₃).

The wiring layer 10 is embedded in an element body 2 which is a resin containing magnetic powder. The main surface direction of the element body 2 and the main surface direction of the wiring layer 10 are substantially parallel.

The circuit pattern 12 is one conductor formed in the spiral shape along the main surface direction of the wiring layer 10. The insulating layer 11 includes a support layer 11a that extends in the main surface direction of the wiring layer 10 and supports the circuit pattern 12.

A circuit connection portion 12a, which is an end portion of the circuit pattern 12, is connected to an external electrode 15 formed on one main surface of the element body 2 using a lead-out wiring 14, which is a wiring conductor formed outside the insulating layer 11. The main surface of the element body 2 on which the external electrode 15 is formed is referred to as an electrode surface 2a. On the electrode surface 2a, a solder resist 16 is applied to a portion other than the external electrode 15. Here, the main surface of the wiring layer 10 may include irregularities in its surface, or may include distortion in a sectional view including a main surface normal.

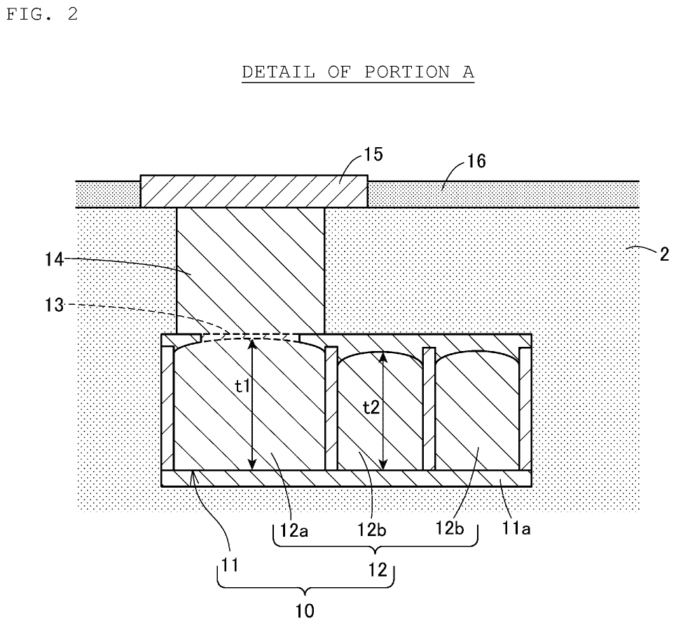

FIG. 2 is a partial detailed view of the wiring layer 10 in a portion A illustrated in FIG. 1. The portion of the wiring layer 10 on the right side in the drawing illustrated in FIG. 1 is similarly configured.

In the present embodiment, the width of the circuit connection portion 12a of the circuit pattern 12 connected to the lead-out wiring 14 is larger than the width of other circuit portions 12b of the circuit pattern 12. The “width of the circuit pattern 12” means a maximum width in a section along a plane orthogonal to the extending direction of the circuit pattern 12.

In particular, in the present embodiment, the thickness t1 of the circuit connection portion 12a of the circuit pattern 12 connected to each of the lead-out wirings 14 is larger than the thickness t2 of the circuit portion 12b which is a portion other than the circuit connection portion 12a of the circuit pattern 12. As a result, in the coil component 1, as compared with the conventional configuration in which the entire circuit pattern is formed with the same thickness, the distance between the circuit connection portion 12a of the circuit pattern 12 and the lead-out wiring 14 is reduced, and the thickness of the interlayer connection portion 13 (the portion surrounded by the dotted line in the drawing) is reduced, so that the circuit pattern 12 and the lead-out wiring 14 can be connected. More precisely, the thickness t1 is a thickness of a portion of the circuit connection portion 12a immediately below the interlayer connection portion 13, and the thickness t2 is an average thickness of the circuit portion 12b. When the thickness of the portion of the circuit connection portion 12a immediately below the interlayer connection portion 13 is measured, the boundary between the circuit connection portion 12a and the interlayer connection portion 13 may be based on the interface displayed in the sectional image captured with a transmission electron microscope.

However, when the thickness t1 is larger than the thickness t2, it is not necessary to strictly and precisely measure each thickness. For example, in a section as illustrated in FIG. 2, when the maximum value of the thickness t1 is clearly larger than the thickness t2, it can be said that the thickness t1 is larger than the thickness t2. Further, for example, if the thickness t2 does not exceed the maximum value at each portion of the circuit portion 12b with respect to the maximum value of the measured thickness t1, and the circuit portion 12b includes a small portion below the maximum value, it can be said that the thickness t1 is larger than the thickness t2. In addition, for example, if the thickness t2 is equal to the maximum value of the measured thickness t1 at some portions of the circuit portion 12b, it can be said that the thickness t1 is larger than the thickness t2 if the ratio of the portion where the thickness t2 is below the maximum value is larger than the ratio of the portion of the circuit portion 12b.

As a result, in the coil component 1, it is possible to reduce the stress applied to the interlayer connection portion 13 due to the variation in environmental temperature or the like, and to improve the connection reliability between the circuit pattern 12 embedded in the insulating layer 11 and the lead-out wiring 14.

The coil component 1 can be manufactured, for example, as follows.

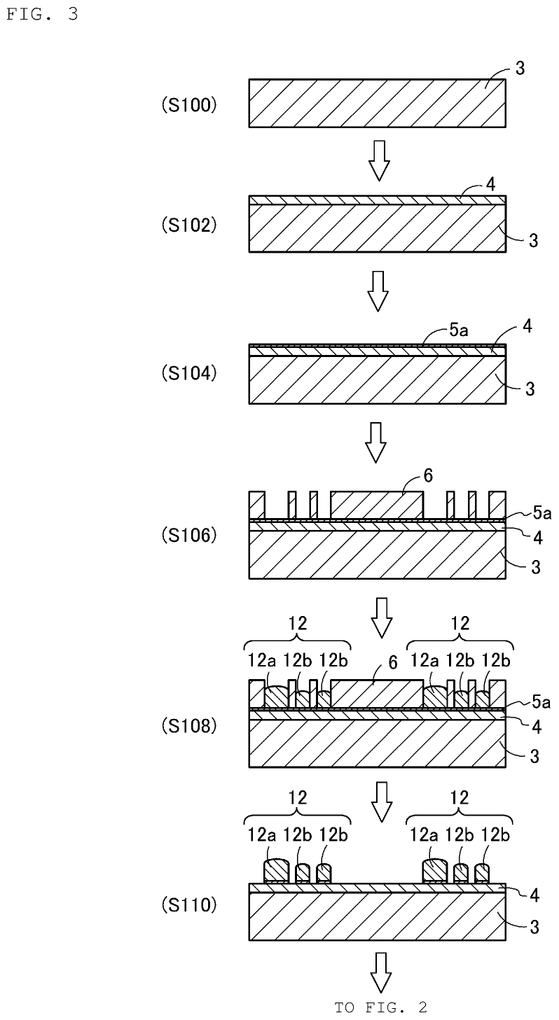

FIGS. 3, 4, and 5 are views illustrating manufacturing steps of the coil component 1.

In FIG. 3, first, a substrate 3 is prepared (S100), and a resin layer 4 which is an insulating resin to be a part of the insulating layer 11 is formed on the substrate 3 (S102). Next, a seed layer 5a is formed on the resin layer 4 (S104). The seed layer 5a is a feed film made of copper metal for performing plating growth by a semi additive process (SAP), and is a metal layer that can be formed by sputtering or electroless plating.

Next, a resist 6 is applied onto the seed layer 5a, and an opening portion for forming the circuit pattern 12 is provided by patterning using photolithography. As a result, a plurality of insulating walls arranged at predetermined intervals on the seed layer 5a is formed as the resist 6 provided with the opening portion (S106). Subsequently, copper metal is grown by plating along the opening portion of the resist 6 between the insulating walls by electrolytic plating to form a circuit pattern 12 (S108), and the resist 6 and the seed layer 5a are removed (S110). Here, in step S106, a wide opening portion, which is formed by making the interval between the resists 6 be larger than the other intervals, is formed at the position where the circuit connection portion 12a is formed. Furthermore, in step S108, by setting the current density in the electrolytic plating to a high current density of 10 Ampere per Square Decimeter (ASD) or more, the growth rate of plating of the wide opening portion is significantly increased as compared with other opening portions, and the circuit pattern 12 having a larger thickness than the other circuit portion 12b is formed in the circuit connection portion 12a formed in the wide opening portion.

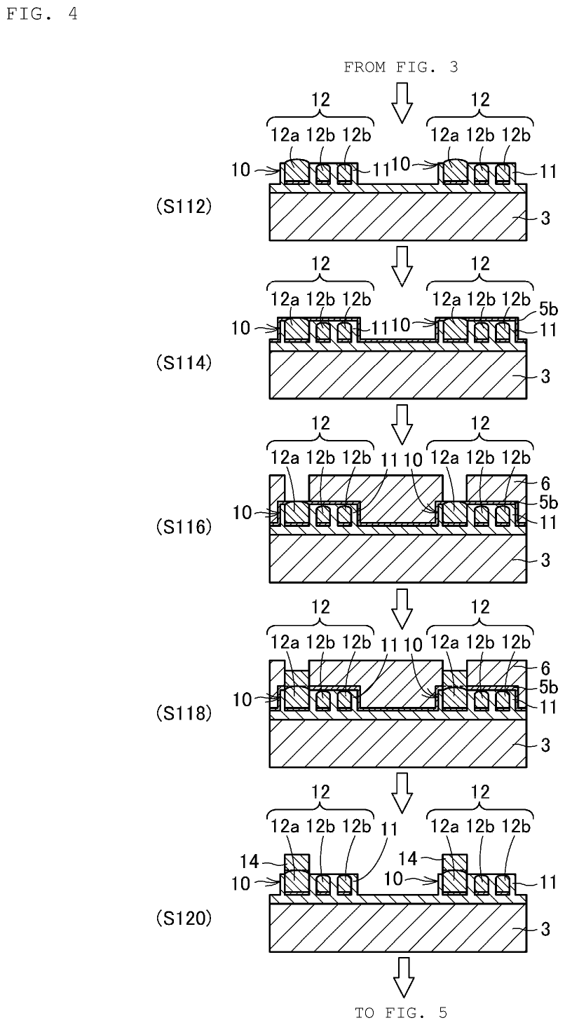

Referring to FIG. 4, next, an insulating resin is patterned to cover the circuit pattern 12 to form the insulating layer 11 (S112). As a result, the wiring layer 10 in which the circuit pattern 12 is embedded in the insulating layer 11 is formed.

Next, a seed layer 5b is formed on the upper surface of the insulating layer 11 (S114). Subsequently, the resist 6 is applied onto the seed layer 5b, and an opening of the resist 6 is formed on the circuit connection portion 12a by patterning using photolithography (S116). Then, electrolytic plating using the seed layer 5b is performed in the opening portion of the resist 6 to form the lead-out wiring 14 on the circuit connection portion 12a (S118), and then the resist 6 is removed (S120).

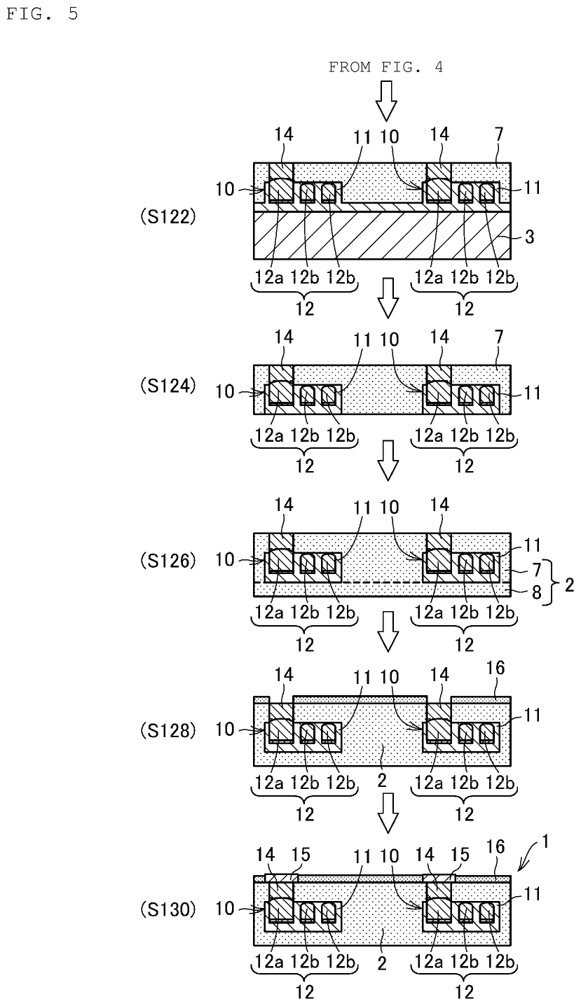

Referring to FIG. 5, next, an upper magnetic layer 7 is formed so as to cover the wiring layer 10 and the lead-out wiring 14, and the upper surface of the lead-out wiring 14 is exposed by grinding the surface (S122). Subsequently, after the substrate 3 is peeled off (S124), a lower magnetic layer 8 is formed (S126). As a result, the wiring layer 10 and the lead-out wiring 14 are embedded in the element body 2 including the upper magnetic layer 7 and the lower magnetic layer 8.

Next, the solder resist 16 is applied to the main surface of the element body 2 on the upper side in the drawing while avoiding the surface of the lead-out wiring 14 (S128), and a conductor of the external electrode 15 is formed on the lead-out wiring 14 by, for example, plating (S130), thereby completing the coil component 1.

### Second Embodiment

Next, a second embodiment will be described.

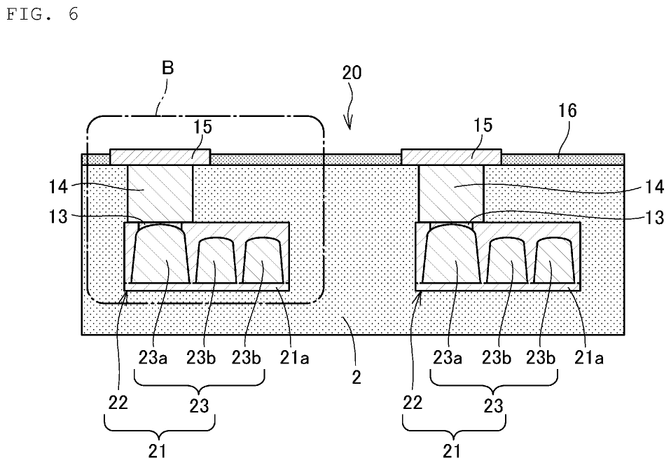

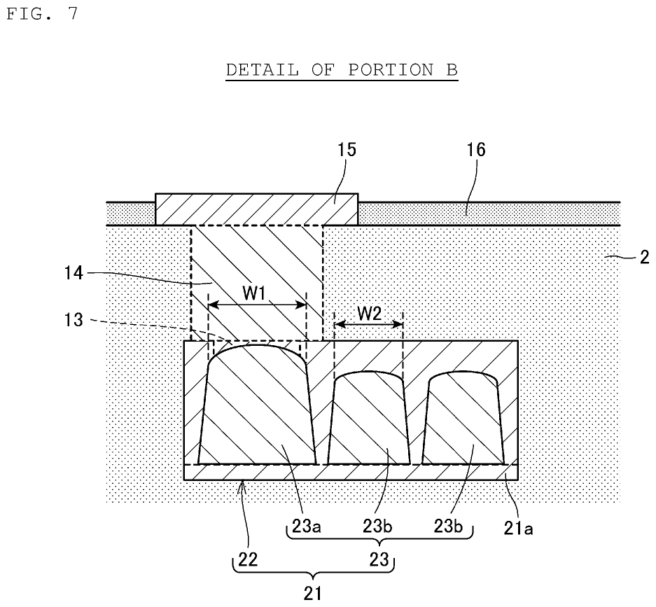

FIG. 6 is a schematic view illustrating an internal structure of a coil component 20 according to a second embodiment of the present disclosure. FIG. 7 is a partial detailed view of a portion B in FIG. 6. In FIGS. 6 and 7, the same components as those of the coil component 1 illustrated in FIGS. 1 and 2 are denoted by the same reference numerals as those illustrated in FIGS. 1 and 2, and the description of FIGS. 1 and 2 described above is incorporated.

The coil component 20 has the same configuration as the coil component 1, but has a wiring layer 21 instead of the wiring layer 10. The wiring layer 21 has the same configuration as the wiring layer 10, but includes an insulating layer 22 and a circuit pattern 23 instead of the insulating layer 11 and the circuit pattern 12. The insulating layer 22 includes a support layer 22a similar to the support layer 11a of the insulating layer 11. In addition, the circuit pattern 23 includes a circuit connection portion 23a and a circuit portion 23b similar to the circuit connection portion 12a and the circuit portion 12b of the circuit pattern 12.

The circuit pattern 23 has the same configuration as the circuit pattern 12, but is different from the circuit pattern 12 in the shape of a section along a plane orthogonal to the extending direction of the circuit pattern 23. That is, the sectional shape of the circuit pattern 23 is a trapezoidal shape in which the length of an upper side which is a side close to the lead-out wiring 14 formed outside the wiring layer 21 is shorter than the length of a lower side facing the upper side. In the circuit pattern 23, the width W1 of the upper side of the trapezoidal shape in the circuit connection portion 23a is larger than the width W2 of the upper side of the trapezoidal shape in the circuit portion 23b which is a portion other than the circuit connection portion 23a.

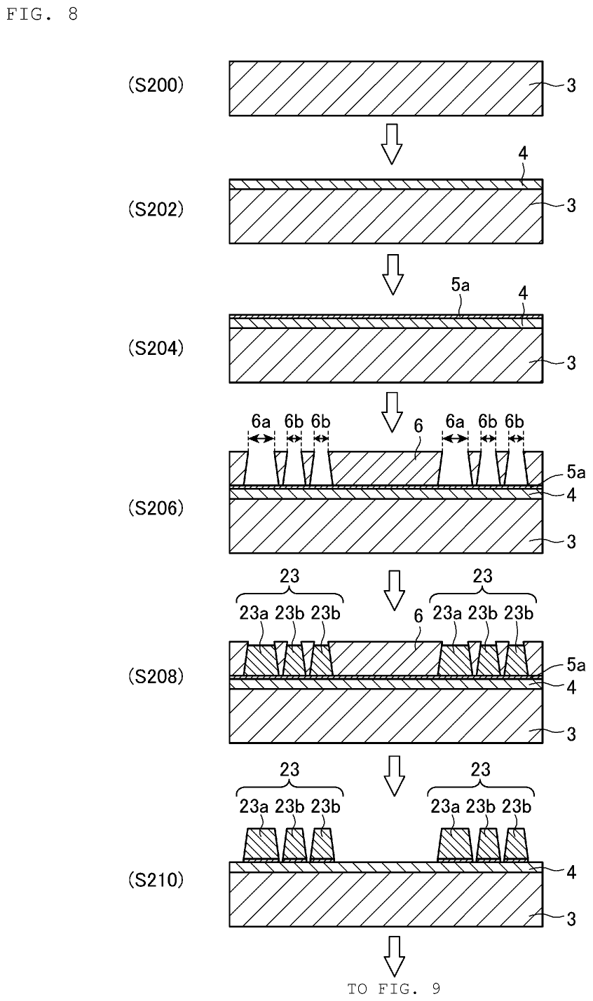

In the coil component 20 having the above configuration, the circuit pattern 23 having a trapezoidal section can be formed by plating growth in an opening portion having a trapezoidal sectional shape formed by, for example, the support layer 21a and a pair of insulating walls provided at positions sandwiching the circuit pattern 23 from the width direction on the support layer 21a. In this case, since the plating solution flows in from the opening portion having a narrow upper side of the opening portion having a trapezoidal sectional shape in which plating growth is performed (see steps S206 and S208 in FIG. 8), circulation of the plating solution in the opening portion is less likely to occur as compared with the case of forming a circuit pattern having a rectangular section, and the difference in plating growth rate with respect to the difference in width of the opening portion becomes large.

Therefore, in the coil component 20, the circuit connection portion 23a having a larger width than that of the circuit portion 23b can be formed to be thicker, and the thickness of the interlayer connection portion 13 can be more easily reduced. As a result, it is possible to reduce the thickness of the interlayer connection portion 13 between the circuit connection portion 23a and the lead-out wiring 14 to reduce the stress applied to the interlayer connection portion 13 due to the variation in environmental temperature or the like, and to improve the connection reliability between the circuit pattern 23 and the lead-out wiring 14.

The coil component 20 can be manufactured, for example, as follows.

FIGS. 8, 9, and 10 are views illustrating manufacturing steps of the coil component 20.

In FIG. 8, first, the substrate 3 is prepared (S200), and the resin layer 4 which is an insulating resin to be a part of the insulating layer 22 is formed on the substrate 3 (S202). Next, the seed layer 5a is formed on the resin layer 4 (S204). The seed layer 5a is a feed film made of copper metal for performing plating growth by SAP, and is a metal layer that can be formed by sputtering or electroless plating.

Next, the resist 6 of a photosensitive resin is applied on the seed layer 5a, and opening portions 6a and 6b for forming the circuit pattern 23 are provided by patterning using photolithography (S206). At this time, on the substrate 3, a focus position of a projection exposure device used for photolithography is set to be shifted upward from the surface of the negative type resist 6, for example. As a result, the resist 6 remaining on the seed layer 5a after development has a reverse tapered shape in which the width decreases toward the substrate 3.

Here, the resist 6 remaining on the seed layer 5a as the metal layer in step S206 corresponds to a plurality of insulating walls arranged at predetermined intervals on the metal layer in the present disclosure. Note that, in a case where the resist 6 is a positive type, by shifting the focus position of the projection exposure device downward from the surface of the resist 6, it is possible to form a section having a similar reverse tapered shape. That is, regardless of whether the resist 6 is a negative type or a positive type, the section of the resist 6 can be formed in a reverse tapered shape by exposing the resist 6 to irradiation light from a projection exposure device set to off-focus with respect to the surface of the resist 6.

Subsequently, copper metal is grown by plating along the opening portion of the resist 6 by electrolytic plating to form the circuit pattern 23 having a trapezoidal section (S208), and the resist 6 and the seed layer 5a are removed (S210). Since the section of the walls of the resist 6 formed in step S206 is formed in a reverse tapered shape, the opening portions 6a and 6b formed between these walls have a smaller width into which the plating solution flows than in a case where the resist walls are rectangular.

For this reason, as the interval between the reverse-tapered walls of the resist 6 becomes smaller, the rate of plating growth greatly decreases. Therefore, in the coil component 20 of the present embodiment in which the circuit pattern 23 having a trapezoidal section is formed, the thickness of the circuit connection portion 23a can be easily formed larger than that of the circuit portion 23b in a state where the current density at the time of plating growth in step S208 is set to be lower than that in the case of the coil component 1 described above (step S108 in FIG. 3).

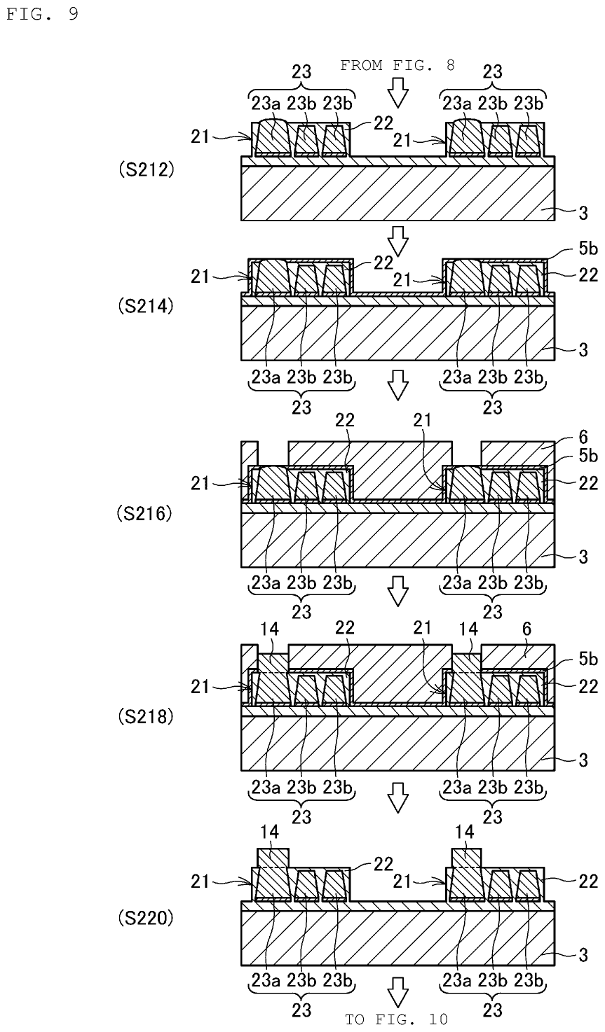

Referring to FIG. 9, next, an insulating resin is patterned to cover the circuit pattern 23 to form the insulating layer 22 (S212). As a result, the wiring layer 21 in which the circuit pattern 23 is embedded in the insulating layer 22 is formed.

Next, the seed layer 5b is formed on the upper surface of the insulating layer 22 (S214). Subsequently, the resist 6 is applied onto the seed layer 5b, and an opening of the resist 6 is formed on the circuit connection portion 23a by patterning using photolithography (S216). Then, electrolytic plating using the seed layer 5b is performed in the opening portion of the resist 6 to form the lead-out wiring 14 on the circuit connection portion 23a (S218), and then the resist 6 is removed (S220).

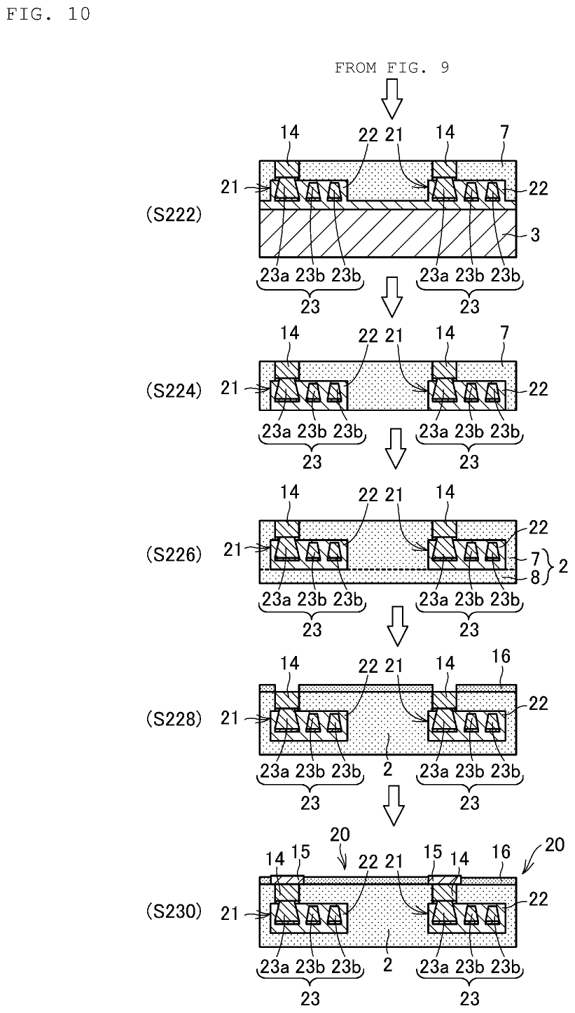

Referring to FIG. 10, next, the upper magnetic layer 7 is formed so as to cover the wiring layer 21 and the lead-out wiring 14, and the upper surface of the lead-out wiring 14 is exposed by grinding the surface (S222). Subsequently, after the substrate 3 is peeled off (S224), the lower magnetic layer 8 is formed (S226). As a result, the wiring layer 21 and the lead-out wiring 14 are embedded in the element body 2 including the upper magnetic layer 7 and the Next, the solder resist 16 is applied to the upper main surface of the element body 2 in the drawing while avoiding the surface of the lead-out wiring 14 (S228), and a conductor of the external electrode 15 is formed on the lead-out wiring 14 by, for example, plating (S230), thereby completing the coil component 20.

### Third Embodiment

Next, a third embodiment will be described.

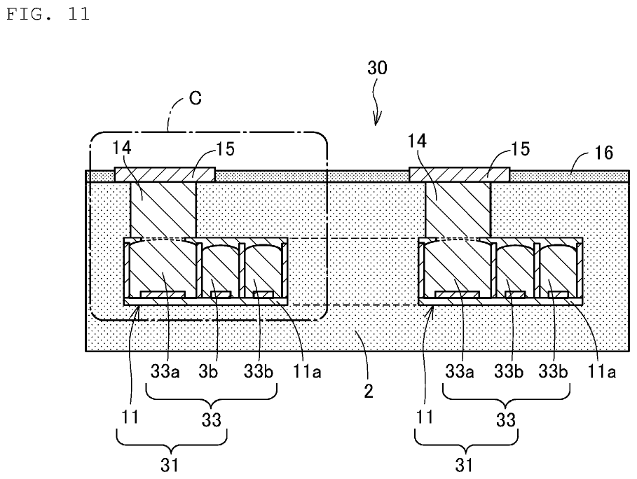

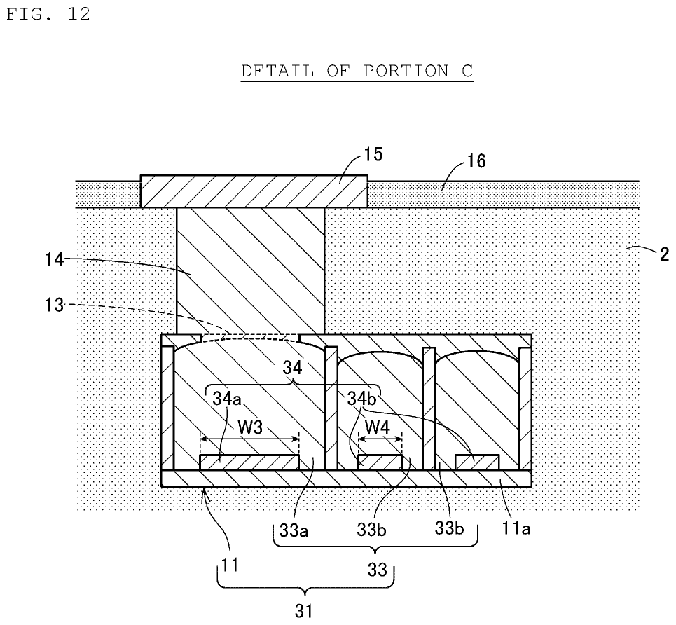

FIG. 11 is a schematic view illustrating an internal structure of a coil component 30 according to a third embodiment of the present disclosure. FIG. 12 is a partial detailed view of a portion C in FIG. 11. In FIGS. 11 and 12, the same components as those of the coil component 1 illustrated in FIGS. 1 and 2 are denoted by the same reference numerals as those illustrated in FIGS. 1 and 2, and the description of FIGS. 1 and 2 described above is incorporated.

The coil component 30 has the same configuration as the coil component 1, but incudes a wiring layer 31 instead of the wiring layer 10. The wiring layer 31 has the same configuration as the wiring layer 10, but includes a circuit pattern 33 instead of the circuit pattern 12. The circuit pattern 33 includes a circuit connection portion 33a and a circuit portion 33b similar to the circuit connection portion 12a and the circuit portion 12b of the circuit pattern 12. The circuit pattern 33 has the same configuration as the circuit pattern 12, but includes a seed pattern 34 formed on the support layer 11a which is a part of the insulating layer 11. The seed pattern 34 is used when the circuit pattern 33 is produced by plating growth using SAP. The seed pattern 34 includes a seed pattern 34a included in the circuit connection portion 33a of the circuit pattern 33 and a seed pattern 34b included in the circuit portion 33b.

In the present embodiment, in particular, the width W3 of the seed pattern 34a included in the circuit connection portion 33a is larger than the width W4 of the seed pattern 34b included in the circuit portion 33b.

As a result, in the coil component 30, at the time of forming the circuit pattern 33, the plating growth rate of the circuit connection portion 33a can be increased higher than the plating growth rate of the circuit portion 33b, and the thickness of the circuit connection portion 33a can be increased with respect to the circuit portion 33b. As a result, it is possible to reduce the thickness of the interlayer connection portion 13 between the circuit connection portion 33a and the lead-out wiring 14 to reduce the stress applied to the interlayer connection portion 13 due to the variation in environmental temperature or the like, and to improve the connection reliability between the circuit pattern 33 and the lead-out wiring 14.

The coil component 30 is manufactured, for example, as follows.

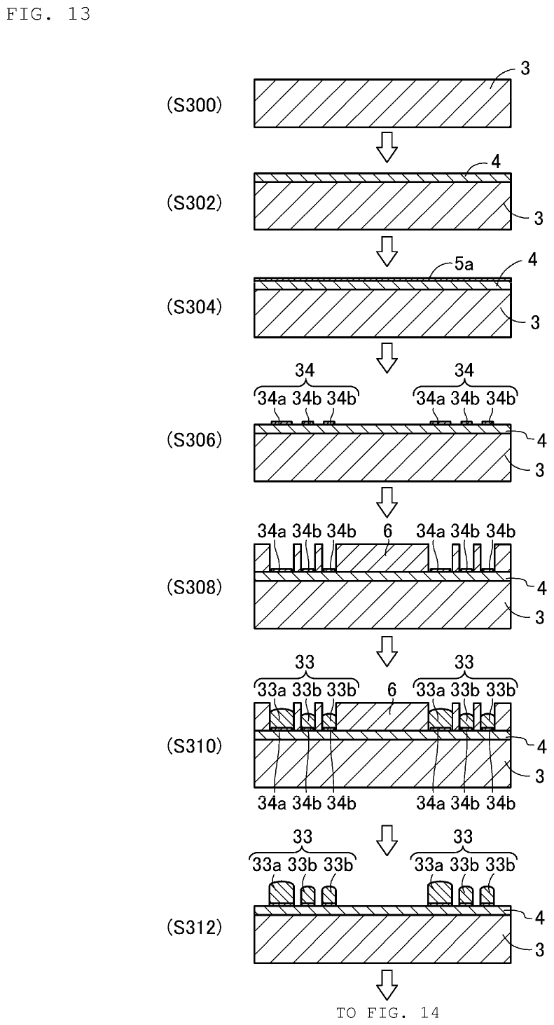

FIGS. 13, 14, and 15 are views illustrating manufacturing steps of the coil component 30.

In FIG. 13, first, the substrate 3 is prepared (S300), and the resin layer 4 which is an insulating resin to be a part of the insulating layer 11 is formed on the substrate 3 (S302). Next, the seed layer 5a is formed on the resin layer 4 (S304). The seed layer 5a is a feed film made of copper metal for performing plating growth by SAP, and is a metal layer that can be formed by sputtering or electroless plating.

Next, the seed layer 5a is patterned by photolithography to form the seed pattern 34 (S306). The seed pattern 34 is used for plating growth of the circuit pattern 33 in a later step. The seed pattern 34 includes the seed pattern 34a used for plating growth of the circuit connection portion 33a and the seed pattern 34b used for plating growth of the circuit portion 33b.

Next, the resist 6 is applied onto the seed layer 5a, and an opening portion for forming the circuit pattern 33 is provided by patterning using photolithography (S308).

Subsequently, copper metal is grown by plating along the opening portion of the resist 6 by electrolytic plating to form the circuit pattern 33 (S310), and the resist 6 and the seed layer 5a are removed (S312).

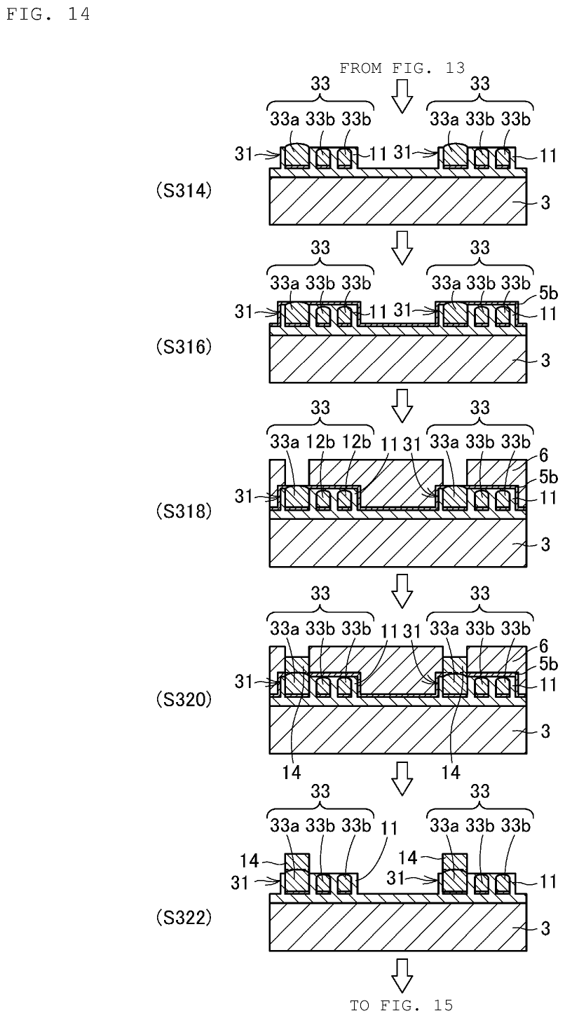

Referring to FIG. 14, next, an insulating resin is patterned to cover the circuit pattern 33 to form the insulating layer 11 (S314). As a result, the wiring layer 31 in which the circuit pattern 33 is embedded in the insulating layer 11 is formed.

Next, the seed layer 5b is formed on the upper surface of the insulating layer 11 (S316). Subsequently, the resist 6 is applied onto the seed layer 5b, and an opening of the resist 6 is formed on the circuit connection portion 33a by patterning using photolithography (S318). Then, electrolytic plating using the seed layer 5b is performed in the opening portion of the resist 6 to form the lead-out wiring 14 on the circuit connection portion 33a (S320), and then the resist 6 is removed (S322).

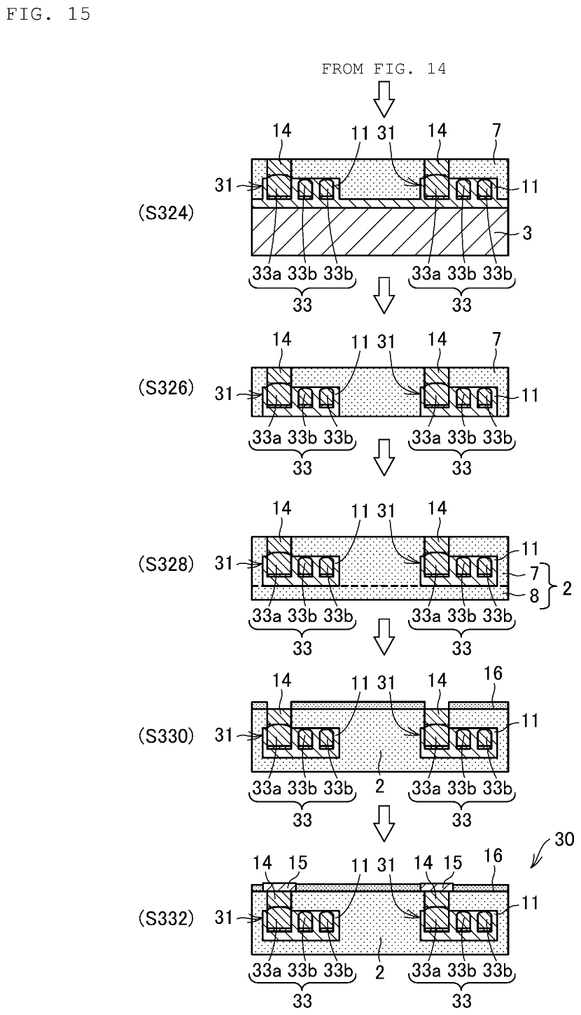

Referring to FIG. 15, next, the upper magnetic layer 7 is formed so as to cover the wiring layer 31 and the lead-out wiring 14, and the upper surface of the lead-out wiring 14 is exposed by grinding the surface (S324). Subsequently, after the substrate 3 is peeled off (S326), the lower magnetic layer 8 is formed (S328). As a result, the wiring layer 31 and the lead-out wiring 14 are embedded in the element body 2 including the upper magnetic layer 7 and the Next, the solder resist 16 is applied to the upper main surface of the element body 2 in the drawing while avoiding the surface of the lead-out wiring 14 (S330), and a conductor of the external electrode 15 is formed on the lead-out wiring 14 by, for example, plating (S332), thereby completing the coil component 30.

### Fourth Embodiment

Next, a fourth embodiment will be described.

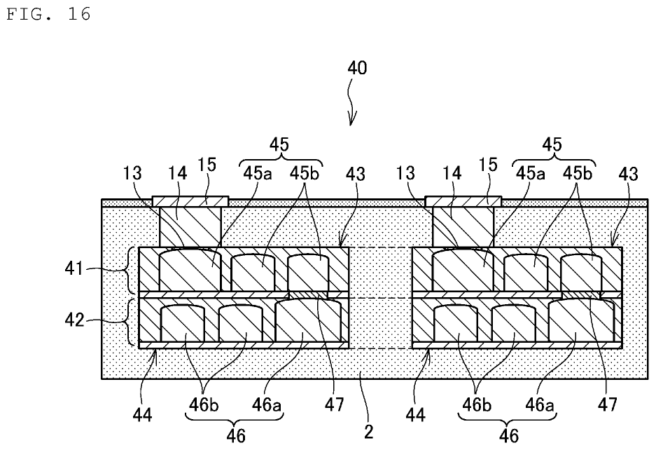

FIG. 16 is a schematic view illustrating an internal structure of a coil component 40 according to a fourth embodiment of the present disclosure. In FIG. 16, the same components as those of the coil component 1 illustrated in FIG. 1 are denoted by the same reference numerals as those in FIG. 1, and the description of FIG. 1 is incorporated.

The coil component 40 includes two wiring layers 41 and 42 stacked in the main surface direction of the element body 2. In the wiring layers 41 and 42, circuit patterns 45 and 46 are embedded in the insulating layers 43 and 44, respectively, similarly to the wiring layer 10.

Similarly to the circuit pattern 12, the circuit pattern 45 includes a circuit connection portion 45a and a circuit portion 45b. The circuit connection portion 45a is connected to the lead-out wiring 14, which is a wiring conductor formed outside the wiring layer 41, by the interlayer connection portion 13 with the opening of the insulating layer 43 interposed therebetween. In the circuit pattern 45, similarly to the circuit pattern 12, the thickness of the circuit connection portion 45a is larger than the thickness of the circuit portion 45b which is a portion other than the circuit connection portion 45a.

Similarly to the circuit pattern 12, the circuit pattern 46 includes a circuit connection portion 46a and a circuit portion 46b. The circuit connection portion 46a is connected to the circuit portion 45b of the circuit pattern 45 of the wiring layer 41, which is a wiring conductor formed outside the wiring layer 42, by an interlayer connection portion 47 with the opening of the insulating layer 44 interposed therebetween. In the circuit pattern 46, similarly to the circuit pattern 12, the thickness of the circuit connection portion 46a is larger than the thickness of the circuit portion 46b which is a portion other than the circuit connection portion 46a.

As a result, in the coil component 40, similarly to the coil component 1, the distance between the circuit connection portion 45a of the circuit pattern 45 and the lead-out wiring 14 can be reduced, and the thickness of the interlayer connection portion 13 can be reduced, so that the circuit pattern 45 and the lead-out wiring 14 can be connected. Similarly, in the coil component 40, the distance between the circuit connection portion 46a of the circuit pattern 46 and the circuit pattern 45 of the wiring layer 41 can be reduced, and the thickness of the interlayer connection portion 47 can be reduced, so that the circuit pattern 46 and the circuit pattern 45 can be connected.

As a result, in the coil component 40, it is possible to reduce stress applied to the interlayer connection portions 13 and 47 due to the variation in environmental temperature or the like, and to improve the connection reliability between the lead-out wiring 14, the circuit pattern 45, and the circuit pattern 46.

In the present embodiment, the coil component 40 includes the two wiring layers 41 and 42, but may include three or more stacked wiring layers. Each circuit pattern of these stacked wiring layers can be provided with a circuit connection portion leading to a wiring conductor outside each wiring layer at any location of those circuit patterns, depending on the design of the coil component 40.

### OTHER EMBODIMENTS

In the above-described embodiments, the coil component 1, 20, 30, or 40 is illustrated as an example of an electronic component having wiring layers. However, an electronic component in which the present disclosure can be implemented can be any electronic component other than the coil component, the electronic component including one or more wiring layers having a sectional structure similar to that of the wiring layer 10, 21, 31, 41, or 42 at a part thereof. A plan view of such a wiring layer is not limited to a ring shape, and may have any shape according to a circuit design in an electronic component.

Furthermore, in the above-described embodiments, the circuit pattern 12 has a spiral shape, but the present disclosure is not limited thereto, and the circuit pattern 12 may have a circling shape of less than 1 turn, a linear shape, a meander shape, or the like.

In the above-described embodiments, the external electrode 15 is separately formed on the end surface of the lead-out wiring 14, but the present disclosure is not limited thereto, and the external electrode 15 may be an end surface of the lead-out wiring 14. That is, the wiring conductor may be the lead-out wiring 14 and the external electrode 15. The external electrode 15 is formed by using an arbitrary forming method such as coating, plating, or sputtering, and may be made of any material such as copper, silver, nickel, tin, or gold. The external electrode 15 may have a stacked structure including a plurality of different layers.

In addition, in the above-described embodiments, the insulating layer 11 is an insulating resin, but may be a sintered body of glass, alumina, ferrite, or the like. In addition, the insulating layer 11 may have the same configuration as the element body 2 and be integrated with the element body 2.

In addition, the characteristic configurations and the manufacturing methods thereof described in the above-described embodiments can be used in combination with each other in any electronic component. For example, any number of wiring layers having the same configuration as the wiring layers 10, 21, 31, 41, and 42 may be arbitrarily combined and used in one electronic component. For example, in the second, third, and fourth embodiments, the high current density electrolytic plating of the first embodiment may be combined, in the first, third, and fourth embodiments, the reverse tapered insulating wall of the second embodiment may be combined, and in the first, second, and fourth embodiments, the seed pattern of the third embodiment may be combined. In particular, the method of making the thickness of the circuit connection portion larger than the thickness of the portion other than the circuit connection portion may be any of the methods exemplified in the first, second, and third embodiments, and is not limited thereto.

Note that all the above-described embodiments illustrate one aspect of the present disclosure, and can be arbitrarily modified and applied without departing from the gist of the present disclosure.

In addition, directions such as horizontal and vertical directions, various numerical values, shapes, and materials in the above-described embodiments include a range (so-called equivalent range) in which the same functions and effects as those of the directions, numerical values, shapes, and materials are exhibited unless otherwise specified.

### Configurations Supported by Above Embodiments

The above-described embodiments support the following configurations.

(Configuration 1) An electronic component including: an insulating layer; a circuit pattern embedded in the insulating layer; a wiring conductor formed outside the insulating layer; and an interlayer connection portion that connects a circuit connection portion, which is a part of the circuit pattern, and the wiring conductor with an opening of the insulating layer interposed therebetween, in which, in the circuit pattern, a thickness of a portion immediately below the interlayer connection portion of the circuit connection portion is larger than an average thickness of a portion other than the circuit connection portion.

According to the electronic component of the configuration 1, since the thickness of the interlayer connection portion can be reduced by reducing the distance between the circuit connection portion, which is a part of the circuit pattern embedded in the insulating layer, and the wiring conductor, the connection reliability between the circuit pattern and the wiring conductor outside the insulating layer can be improved.

(Configuration 2) The electronic component according to the configuration 1, in which, in the circuit pattern, a width of the circuit connection portion is larger than a width of a portion other than the circuit connection portion.

According to the electronic component of the configuration 2, in the circuit pattern, the thickness of the circuit connection portion can be easily formed larger than the thickness of the portion other than the circuit connection portion.

(Configuration 3) The electronic component according to the configuration 1, in which a shape of a section of the circuit pattern along a plane orthogonal to an extending direction of the circuit pattern is a trapezoidal shape in which a length of an upper side which is a side close to the wiring conductor is shorter than a length of a lower side facing the upper side, and in which, in the circuit pattern, a width of the upper side of the trapezoidal shape in the circuit connection portion is larger than a width of an upper side of the trapezoidal shape in a portion other than the circuit connection portion.

According to the electronic component of the configuration 3, when the circuit pattern is formed by plating growth, the difference in plating growth rate with respect to the width of the circuit pattern is increased, and the thickness of the circuit connection portion can be easily formed larger than the thickness of the portion other than the circuit connection portion.

(Configuration 4) The electronic component according to the configuration 1 or 2, in which the circuit pattern has a seed pattern extending along the circuit pattern on a bottom surface which is a surface on a side far from the wiring conductor, and in which, in the seed pattern extending along the bottom surface, a width of the circuit connection portion is larger than a width of a portion other than the circuit connection portion.

According to the electronic component of the configuration 4, the thickness of the circuit connection portion can be easily formed larger than the thickness of the portion other than the circuit connection portion.

(Configuration 5) The electronic component according to any one of the configurations 1 to 4, further including at least two of the circuit patterns stacked in a direction orthogonal to a main surface of the insulating layer.

According to the electronic component of the configuration 5, in the connection between the plurality of stacked circuit patterns, the thickness of the interlayer connection portion can be reduced, and the reliability of the connection can be improved.

(Configuration 6) A coil component which is the electronic component according to any one of the configurations 1 to 5, in which the circuit pattern constitutes a coil.

According to the coil component of the configuration 6, a good connection state between the circuit pattern and the other conductor can be established, and reliability can be improved.

(Configuration 7) A method for manufacturing an electronic component, the method including: a step of forming a plurality of insulating walls arranged at predetermined intervals on a metal layer; and a step of forming a circuit pattern by plating and growing a metal between the insulating walls by electrolytic plating, in which, in the step of forming the insulating walls, a wide opening portion is formed, the wide opening portion being formed by making at least one of the intervals be larger than others of the intervals, and in which, in the step of forming the circuit pattern, a circuit pattern having a thickness of the wide opening portion that is larger than that of the other opening portion is formed in by setting a current density in the electrolytic plating to 10 ASD or more.

According to the method for manufacturing an electronic component of the configuration 7, the thickness of the circuit pattern formed in the wide opening portion can be easily formed larger than the thickness of the circuit pattern formed in the other opening portion, so that the connection reliability between the circuit pattern and the wiring conductor can be improved when the wiring conductor is formed on the circuit pattern in the wide opening portion.

(Configuration 8) A method for manufacturing an electronic component, the method including: a step of forming a plurality of insulating walls arranged at predetermined intervals on a metal layer; and a step of forming a circuit pattern by plating and growing a metal between the insulating walls by electrolytic plating, in which, in the step of forming the insulating walls, a wide opening portion is formed, the wide opening portion being formed by making at least one of the intervals be larger than others of the intervals, and a photosensitive resin is exposed to irradiation light with respect to a surface of the photosensitive resin formed on the metal layer from a projection exposure device set to off-focus, so that a section of the insulating wall along a plane orthogonal to an extending direction of the circuit pattern is formed in a reverse tapered shape in which a width decreases toward the metal layer, and the step of forming the circuit pattern including forming the circuit pattern having a thickness of the wide opening portion that is larger than that of the other opening portion by making circulation of a plating solution flowing into the opening portion less likely to occur in the other opening portion than the wide opening portion by the insulating wall having a reverse tapered shape.

According to the method for manufacturing an electronic component of the configuration 8, the thickness of the circuit pattern formed in the wide opening portion can be easily formed larger than the thickness of the circuit pattern formed in the other opening portion, so that the connection reliability between the circuit pattern and the wiring conductor can be improved when the wiring conductor is formed on the circuit pattern in the wide opening portion.

What is claimed is:

1. An electronic component comprising:
an insulating layer;
a circuit pattern embedded in the insulating layer;
a wiring conductor outside the insulating layer; and
an interlayer connection portion that connects a circuit connection portion, which is a part of the circuit pattern, and the wiring conductor via an opening of the insulating layer,
wherein a thickness of a portion of the circuit connection portion of the circuit pattern, the portion being located below the interlayer connection portion, is larger than an average thickness of a portion other than the circuit connection portion of the circuit pattern.

2. The electronic component according to claim 1, wherein
a width of the circuit connection portion of the circuit pattern is larger than a width of a portion other than the circuit connection portion.

3. The electronic component according to claim 1, wherein
a cross-sectional shape of the circuit pattern along a plane orthogonal to an extending direction of the circuit pattern is a trapezoidal shape in which a length of an upper side which is close to the wiring conductor is shorter than a length of a lower side facing the upper side, and
a width of the upper side of the trapezoidal shape in the circuit connection portion of the circuit pattern is larger than a width of an upper side of the trapezoidal shape in the portion other than the circuit connection portion of the circuit pattern.

4. The electronic component according to claim 1,
wherein the circuit pattern includes a seed pattern extending along a bottom surface of the circuit pattern which is a surface being far from the wiring conductor, and
wherein a width of the seed pattern extending along the bottom surface in the circuit connection portion of the circuit pattern is larger than a width of the seed pattern in the portion other than the circuit connection portion of the circuit pattern.

5. The electronic component according to claim 1, further comprising:
at least two of the circuit patterns stacked in a direction orthogonal to a main surface of the insulating layer.

6. A coil component which is the electronic component according to claim 1, wherein
the circuit pattern is configured as a coil.

7. A coil component which is the electronic component according to claim 2, wherein
the circuit pattern is configured as a coil.

8. A coil component which is the electronic component according to claim 3, wherein
the circuit pattern is configured as a coil.

9. A coil component which is the electronic component according to claim 4, wherein
the circuit pattern is configured as a coil.

10. A coil component which is the electronic component according to claim 5, wherein
the circuit pattern is configured as a coil.

11. A method for manufacturing an electronic component, the method comprising:
forming a plurality of insulating walls arranged at predetermined intervals on a metal layer; and
forming a circuit pattern by plating and growing a metal between the insulating walls by electrolytic plating,
wherein
the forming of the insulating walls includes forming a wide opening portion by making at least one of the intervals be wider than other intervals, and
the forming of the circuit pattern includes forming a circuit pattern having a thickness of the circuit pattern in the wide opening portion that is larger than a thickness of the circuit pattern in the other opening portion by setting a current density in the electrolytic plating to 10 ASD or more.

12. A method for manufacturing an electronic component, the method comprising:
forming a plurality of insulating walls arranged at predetermined intervals on a metal layer; and
forming a circuit pattern by plating and growing a metal between the insulating walls by electrolytic plating,
wherein the forming of the insulating walls includes
forming a wide opening portion by making at least one of the intervals be wider than other intervals, and
exposing a photosensitive resin formed on the metal layer with an irradiation light from a projection exposure device, which is set to off-focus with respect to a surface of the photosensitive resin, wherein a cross section of the insulating wall along a plane orthogonal to an extending direction of the circuit pattern is formed in a reverse tapered shape in which a width of the insulating wall decreases toward the metal layer, and
the forming of the circuit pattern includes
forming the circuit pattern having a thickness of the circuit pattern in wide opening portion that is larger than a thickness of the circuit pattern in the other opening portion by making circulation of a plating solution flowing into the opening portion less likely to occur in the other opening portion than the wide opening portion by the insulating wall having the reverse tapered shape.
